(19) United States
(12) Patent Application Publication
(10) Pub. No.: US 2010/0247173 A1
(43) Pub. Date: Sep. 30, 2010

(54) Image Forming Apparatus

(75) Inventor: Yasushi OKABE, Nagoya-shi (JP)

Correspondence Address: BANNER & WITCOFF, LTD.;ATTORNEYS FOR CLIENT NO. 016689, 1100 13th STREET, N.W., SUITE 1200, WASHINGTON, DC, 20005-4051, US

(73) Assignee: BROTHER KOGYO KABUSHIKI KAISHA, Nagoya-shi (JP)

(21) Appl. No.: 12/731,778

(22) Filed: Mar. 25, 2010

(30) Foreign Application Priority Data
Mar. 26, 2009 (JP) 2009-075701

(51) Int. Cl. G03G 15/01; G03G 15/16

(52) U.S. Cl. 399/302; 399/316

(57) ABSTRACT

An image forming apparatus includes: an intermediate transfer belt to which a toner image formed on a photosensitive drum is primarily transferred; a driving roller configured to supply a driving force to the belt; a tension roller provided to be movable with respect to the driving roller to apply tension to the belt; a secondary transfer roller configured to transfer the toner image transferred to the belt onto a sheet; and a guide member configured to guide the sheet to a nip position between the secondary transfer roller and the belt. The driving roller is provided to support a downstream end of the belt in a direction in which the toner image is conveyed. The secondary transfer roller opposes the tension roller. The guide member is connected to the tension roller so as to follow a movement of the tension roller.

### CROSS-REFERENCE TO RELATED APPLICATION

This application claims priority from Japanese Patent Application No. 2009-075701, filed on Mar. 26, 2009, the entire subject matter of which is incorporated herein by reference.

### TECHNICAL FIELD

Aspects of the present invention relate to an intermediate transfer type image forming apparatus.

### BACKGROUND

An intermediate transfer type image forming apparatus transfers a toner image formed on a photosensitive drum to an intermediate transfer belt and then transfers the toner image on the intermediate transfer belt onto a sheet.

Inside of the intermediate transfer belt, there is provided a driving roller which supplies a driving force to the intermediate transfer belt, a tension roller which applies tension to the intermediate transfer belt, and a driven roller which defines a movement path of the intermediate transfer belt at a position opposing a secondary transfer roller. The intermediate transfer belt has a primary transfer area, to which a toner image formed on each photosensitive drum is primarily transferred, at a position opposing the photosensitive drum. The toner image on the primary transfer area is conveyed with a rotation of the intermediate transfer belt. In a conveying direction in which the toner image is conveyed, an upstream end of the primary transfer area is supported by the tension roller and a downstream end thereof is supported by the driving roller.

As described above, since the downstream end of the primary transfer area is supported by the driving roller, the primary transfer area is reliably stretched by a driving force from the driving roller, and thus a primary transfer can be effectively performed.

However, in such a configuration that the downstream end of the primary transfer area in the conveying direction of the toner image is supported by the driving roller, there is a case where it is preferable to provide the tension roller to oppose the secondary transfer roller while considering arrangement of the components in the image forming apparatus (for example, a transport path of a sheet).

Even in a case where the tension roller is provided to oppose the secondary transfer roller, it is generally considered to provide a guide member which guides a sheet to a secondary transfer nip position between the tension roller and the secondary transfer roller.

However, since the tension roller is configured to move slightly so as to keep the intermediate transfer belt being in a tensioned state by absorbing the stretching of the belt, an error in the belt perimeter or the like, the guide member can not guide a sheet to an accurate transfer nip position. Accordingly, a problem would occur that a secondary transfer of the toner image onto a sheet can not be accurately performed.

### SUMMARY

Accordingly, it is an aspect of the present invention to provide an image forming apparatus in which a secondary transfer of a toner image onto a sheet can be accurately performed.

According to an illustrative embodiment of the present invention, there is provided an image forming apparatus comprising: an intermediate transfer belt having a primary transfer area to which a toner image formed on a photosensitive drum is primarily transferred; a driving roller configured to supply a driving force to the intermediate transfer belt; a tension roller provided to be movable with respect to the driving roller to apply tension to the intermediate transfer belt; a secondary transfer roller configured to transfer the toner image transferred to the intermediate transfer belt onto a sheet; and a guide member configured to guide the sheet to a nip position between the secondary transfer roller and the intermediate transfer belt, wherein the driving roller is provided to support a downstream end of the primary transfer area in a direction in which the toner image transferred on the primary transfer area is conveyed, wherein the secondary transfer roller is provided at a position opposing the tension roller, and wherein the guide member is connected to the tension roller so as to follow a movement of the tension roller.

According to another illustrative embodiment of the present invention, there is provided an image forming apparatus comprising: a driving roller; a tension roller provided to be movable with respect to the driving roller; an intermediate transfer belt which is turned around the driving roller and the tension roller, and to which a toner image formed on a photosensitive drum is transferred; a pressing member which presses the tension roller to the intermediate transfer belt; a secondary transfer unit provided to be movable with respect to the driving roller and including a secondary transfer roller opposing the tension roller with the intermediate transfer belt therebetween; a sheet transport unit configured to transport a sheet through between the tension roller and the secondary transfer roller; and a connecting member provided to be movable between a position which connects a rotating shaft of the tension roller and the secondary transfer unit and a position which does not connect the rotating shaft of the tension roller and the secondary transfer unit.

### BRIEF DESCRIPTION OF THE DRAWINGS

The above and other aspects of the present invention will become more apparent and more readily appreciated from the following description of illustrative embodiments of the present invention taken in conjunction with the attached drawings, in which:

FIG. 1 is a side sectional view showing a schematic configuration of a color laser printer as an example of an image forming apparatus according to a first illustrative embodiment;

FIG. 2 is a left side view of a secondary transfer unit in the color laser printer;

FIG. 3 is an enlarged view of a portion where the secondary transfer unit opposes a tension roller in FIG. 1;

FIG. 4A is an explanatory view showing a state in which the secondary transfer unit and the tension roller 73 are connected to each other;

FIG. 4B is an explanatory view showing a state in which a connecting member in FIG. 4A is not illustrated;

FIG. 5A is a side sectional view of the color laser printer when a rear cover is opened;

FIG. 5B is a side sectional view of the color laser printer when the secondary transfer unit is opened;

FIG. 6A is a left side view of the secondary transfer unit; and

FIG. 6B is a left side view in which the connecting member in FIG. 6A is not illustrated.

### DETAILED DESCRIPTION

Hereinafter, illustrative embodiments of the present invention will be described with reference to the accompanying drawings.

### First Illustrative Embodiment

### Overall Configuration of Color Laser Printer

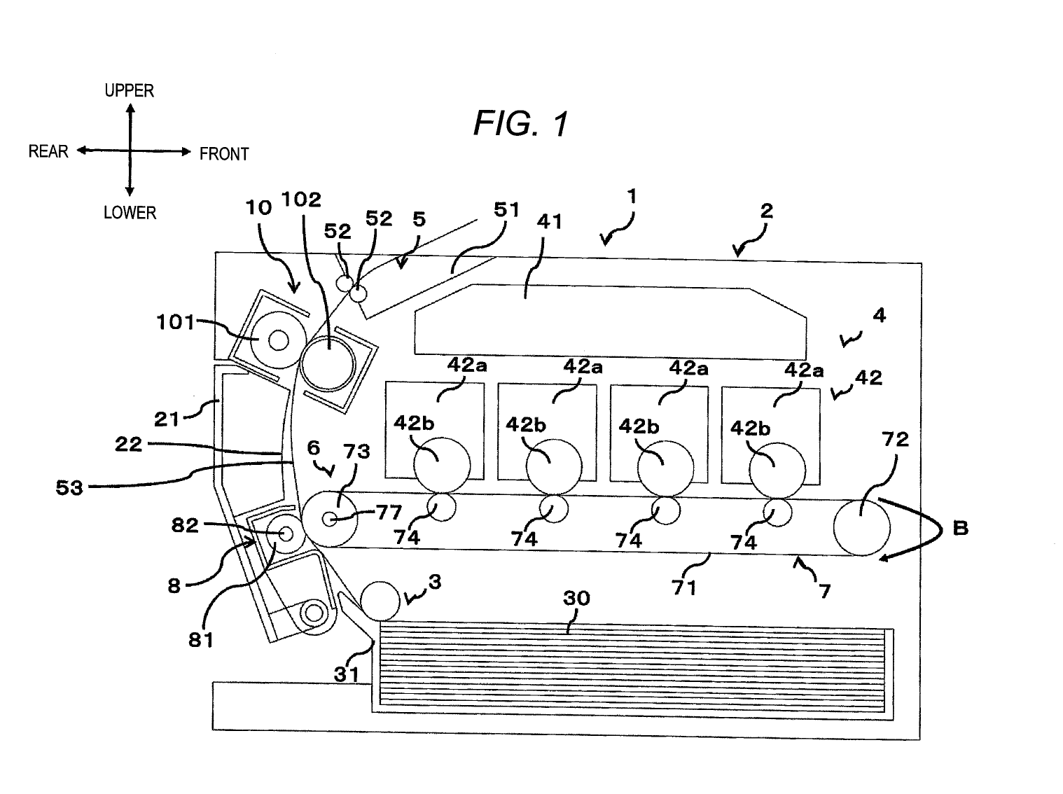

A color laser printer 1 is shown in FIG. 1 as an example of an image forming apparatus according to an illustrative embodiment of the preset invention. The printer 1 includes a body housing 2, and further includes, within the body housing 2, a sheet feeding section 3 configured to feed a sheet 30 to an image forming section 4, the image forming section 4 configured to form an image on the fed sheet 30, and a sheet discharging section 5 configured to discharge the sheet 30 on which the image has been formed.

For ease of discussion, in the following description, directions are defined as viewed from a user who operates the printer 1. The top or upper side, the bottom or lower side, the left or left side, the right or right side, the front or front side, and the rear or rear side of the printer 1 are identified as indicated by the arrows in drawings. Further, herein the left-right direction is also referred to as a width direction, and the upper-lower direction is also referred to as a vertical direction. The left-right direction and the front-rear direction are also referred to as a horizontal direction. With regard to various individual components of the printer 1, sides of the individual components are similarly identified based on the arranged/attached position of the components on/in the printer 1.

The body housing 2 has a rear cover 21 at a rear side thereof. The rear cover 21 has a cover side guide section 22 configured to guide the sheet 30 transported from a secondary transfer nip position toward a fixing section 10. The rear cover 21 is rotatably supported about a lower end of the rear cover 21 and is configured to be opened and closed.

(1) Sheet Feeding Section

The sheet feeding section 3 is provided at a lower side in the body housing 2 and includes a sheet tray 31 in which sheets 30 are stacked.

(2) Image Forming Section

The image forming section 4 includes a scanner section 41, a process section 42, a transfer section 6 and a fixing section 10.

(2-1) Scanner Section

The scanner section 41 is provided at an upper side in the body housing 2 and includes a laser light source, a polygon mirror, a lens and a reflective mirror (all not shown). In the scanner section 41, a laser light emitted from the laser light source for each color based on image data are scanned at high speed in the right and left direction by the polygon mirror, transmitted through the lens, reflected by the reflective mirror, and then irradiated to each of the photosensitive drums 42b of the process sections 42.

(2-2) Process Section

The process section 42 is provided below the scanner section 41 and above the sheet feeding section 3, and includes four process units 42a.

Each of the process units 42a includes a photosensitive drum 42b, a charger, a developing device, and the like (not shown) as a unit. The charger and the developing device are provided around each of the photosensitive drum 42b.

(2-3) Transfer Section

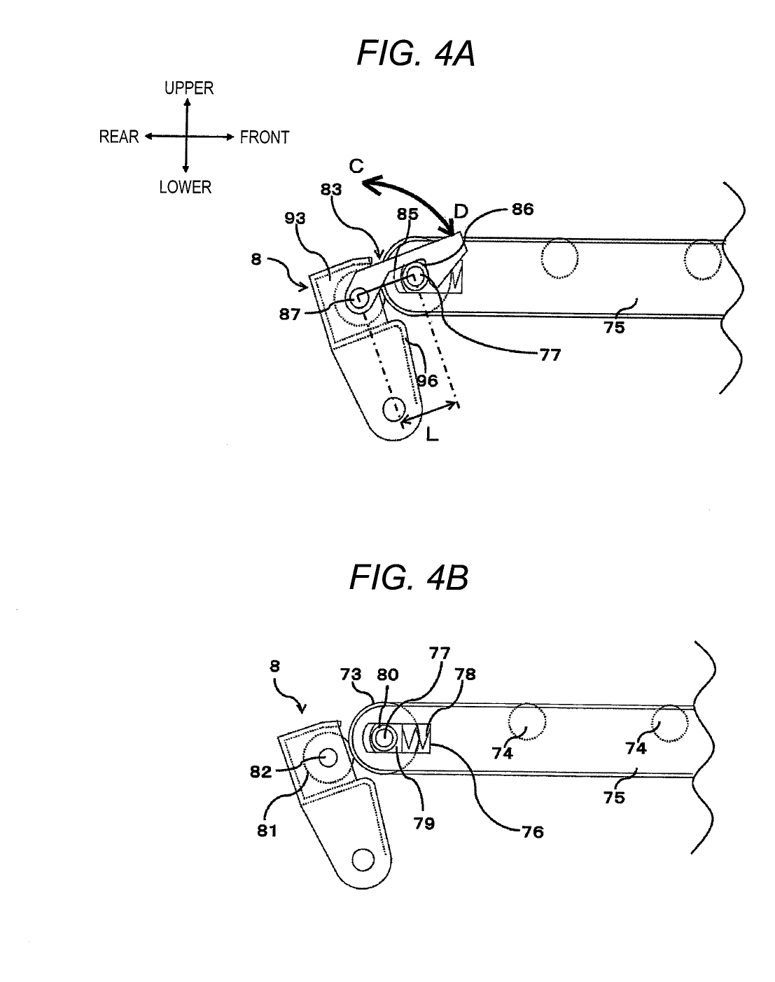

Next, the transfer section 6 will be described with reference to FIGS. 1, 4A and 4B. As shown in FIG. 1, the transfer section 6 includes a belt unit 7 and the second transfer unit 8.

The belt unit 7 includes an intermediate transfer belt 71 having a primary transfer area to which a toner image formed on each of the photosensitive drum 42b is primarily transferred, a driving roller 72 configured to supply a driving force to the intermediate transfer belt 71, a tension roller 73 configured to apply an appropriate tension to the intermediate belt 71, a primary transfer roller 74 and a side wall 75 (see FIG. 4A or 4B). The side wall 75 supports the driving roller 72, the tension roller 73 and the primary transfer roller 74.

The intermediate transfer belt 71 is an endless belt and turned around the driving roller 72, the tension roller 73 and the primary transfer roller 74. The intermediate transfer belt 71 is rotationally driven in a direction of arrow B by the driving roller 72.

The primary transfer area is a straight portion and provided to oppose each of the photosensitive drums 42b, in the intermediate transfer belt 71. An upstream end of the primary transfer area in a movement direction of the intermediate transfer belt 71 is supported by the tension roller 73 and a downstream end thereof is supported by the driving roller 72. Since the driving roller 72 is configured to support the downstream end of the primary transfer area, the primary transfer area can be reliably kept in a stretched state.

As shown in FIG. 4B, the tension roller 73 has a rotating shaft 77 and a first rotating shaft supporting member 79 which rotatably supports the rotating shaft 77. The first rotating shaft supporting member 79 includes a protruding section 80 which has a diameter larger than that of the rotating shaft 77 of the tension roller 73 and protrudes in an extending (axial) direction of the rotating shaft 77.

A supporting hole section 76 which supports the first rotating shaft supporting member 79 is formed in the side wall 75.

The supporting hole section 76 has an elongated hole shape which is long in a stretching direction (a front-rear direction) of the intermediate transfer belt. The supporting holes section 76 has a spring 78 which applies tension to the intermediate transfer belt 71. The spring 78 is positioned at a front side of the supporting hole section 76 and presses the first rotating shaft supporting member 79 of the tension roller 73. Accordingly, the tension roller 73 is movable slightly within the supporting hole section 76 in the front-rear direction. That is, the tension roller 73 is movable with respect to the driving roller 72.

As shown in FIG. 1, each of the primary transfer roller 74 is provided to interpose the primary transfer area at a position opposing the corresponding photosensitive drum 42b inside of the intermediate transfer belt 71.

Although it will be described in detail below, the secondary transfer unit 8 is provided at a rear side of the tension roller 73 such that a second transfer roller 81 opposes the tension roller 73.

(2-4) Fixing Section

As show in FIG. 1, the fixing section 10 is provided at an upper side of the secondary transfer unit 8 and at a downstream side in a sheet transport direction, and includes a pressing roller 101 and a heating roller 102.

The pressing roller 101 and the heating roller 102 are provided to pressure-contact with each other, and transport the sheet 30 while interposing it therebetween so that the toner image on the sheet 30 is heat-fixed.

(3) Sheet Discharging Section

As shown in FIG. 1, the sheet discharging section 5 includes a sheet discharging tray 51 which is a recess provided on an upper surface of the body housing 2. The sheet 30 discharged by discharge rollers 52 is stacked in the sheet discharging tray 51. Accordingly, the sheet 30 transported from the sheet tray 31 is discharged to the sheet discharging tray 51 through a C-shaped sheet transport path 53 provided at a rear side.

(Configuration of Secondary Transfer Unit)

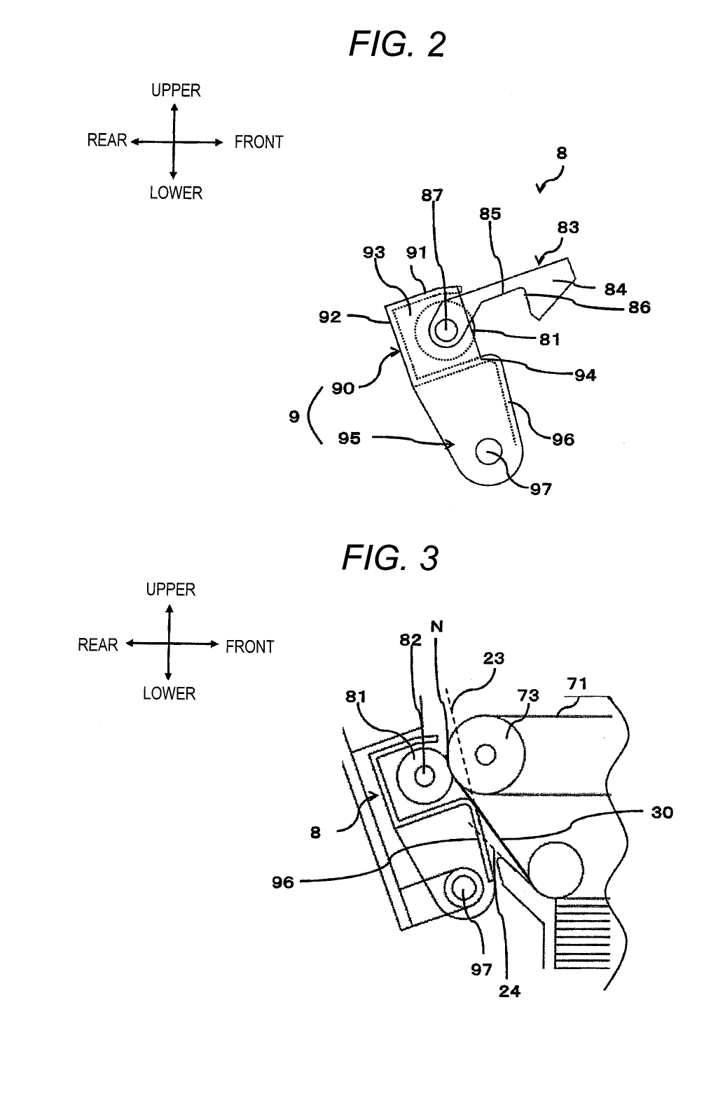

Next, the configuration of the secondary transfer unit 8 will be described with reference to FIGS. 2, 3, 4A and 4B. In the following, unless otherwise noted, the configuration of the secondary transfer unit 8 will be described assuming that the right and left sides are same.

As shown in FIG. 2, the secondary transfer unit 8 includes a unit frame 9, the secondary transfer roller 81 and a connecting member 83.

The unit frame 9 includes a first frame 90 which covers the secondary transfer roller 81 and a second frame 95 which has a guide member 96 configured to guide the sheet 30.

The first frame 90 includes a top frame 91 which covers an upper side of the secondary transfer roller 81, a rear frame 92 which covers a rear side of the secondary transfer roller 81, side frames 93 which cover both right and left sides of the secondary transfer roller 81 and a bottom frame 94 which covers a lower side of the secondary transfer roller 81. A front side of the first frame has no frame to cover the secondary transfer roller 81 and is opened so that the secondary transfer roller 81 and the intermediate transfer belt 71 are in contact with each other.

The second frame 95 includes a guide member 96 which extends downwards from a front side end of the bottom frame 94 and a frame rotating shaft section 97 which rotatably supports the secondary transfer unit 8.

The guide member 96 is provided at an upstream side from a nip position N of the secondary transfer roller 81 and the tension roller 73 in a sheet transport direction and is longer than a sheet width in a width direction (a right and left direction) of the sheet 30. Further, the guide member 96 is configured to guide a leading end of the transported sheet 30 to a side of the secondary transfer roller 81 with respect to a tangential direction 23 of the guide member 96 and to a side of the tension roller 73 with respect to the secondary transfer nip position N. By guiding the leading end of the sheet 30 to the side of the tension roller 73 as described above, the occurrence of discharge in front of the secondary transfer nip position N can be reduced or prevented. The guide member 96 is provided at a position where the guide member 96 intersects with a sheet feed direction 24 from the sheet tray 31.

The frame rotating shaft section 97 is provided at an upstream side in the sheet transport direction. The secondary transfer unit 8 is supported about the frame rotating shaft 97 to be rotatable between a position at which the secondary transfer roller 81 and the tension roller 73 are in contact with each other and a position at which the secondary transfer roller 81 and the tension roller 73 are separated from each other.

As shown in FIGS. 2, 4A and 4B, the secondary transfer roller 81 is covered by the first frame 90 and has a rotating shaft 82 of the secondary transfer roller 81. The rotating shaft 82 of the secondary transfer roller 81 is rotatably supported by the side frame 93.

The connecting member 83 includes a tip section 84, a recess section 85, a step section 86 and a connecting member rotating section 87.

The tip section 84 has a claw shape which extends in a rotating direction of the connecting member 83 and is configured to support the protruding section 80 toward the secondary transfer roller 81 along a direction in which the secondary transfer roller 81 and the tension roller 73 oppose with each other. The rotating direction of the connecting member 83 includes a D direction and a C direction opposite to the D direction. If the connecting member 83 rotates in the D direction, the connecting member 83 connects with the tension roller 73.

The recess section 85 is positioned between the connecting member rotating section 87 and the tip section 84 and recessed toward the C direction.

The step section 86 is positioned at further outside (front side) from the connecting member rotating section 87 compared to the protruding section 80 in a direction in which the protruding section 80 and the connecting member rotating shaft section 87 oppose with each other when the connecting member 83 is connected. Further, the step section 86 is formed such that a distance L between the rotating shaft 82 of the secondary transfer roller 81 and the rotating shaft 77 of the tension roller 73 is smaller than a length which sums up the radius of the tension roller 73 and the radius of the secondary transfer roller 81. That is, the step section 86 is provided such that the secondary transfer roller 81 generates a nip pressure against the tension roller 73.

The connecting member rotating section 87 is provided to the side frame 93 of the secondary transfer unit 8 as shown in FIG. 4A and has a rotating shaft which is substantially same as the rotating shaft 82 of the secondary transfer roller 81.

(Operation of Secondary Transfer Unit when Tension Roller Moves)

Next, operation of the secondary transfer unit 8 when the tension roller 73 moves will be described with reference to FIG. 4A.

For example, when the printer 1 is operated under high temperature environment, the intermediate transfer belt 71 stretches due to linear expansion. With such stretching of the intermediate transfer belt 71, the tension roller 73 moves rearward due to the spring 78 which applies tension to the intermediate transfer belt 71. If the tension roller 73 moves rearward, the contact pressure between the secondary transfer roller 81 and the tension roller 73 becomes stronger and the force separating the secondary transfer roller 81 from the tension roller 73 becomes larger. Then, the secondary transfer unit 8 having the secondary transfer roller 81 moves rearward. At this time, the connecting member 83 suppresses change of the distance L. Accordingly, even though the secondary transfer unit 8 moves, the distance L is kept substantially unchanged.

With such movement of the tension roller 73, the secondary transfer unit 8 having the secondary transfer roller 81 moves, and thus the guide member 96 included in the secondary transfer unit 8 also moves accordingly.

In contrast, the intermediate transfer belt 71 contracts and thus the tension roller 73 moves forward when the printer 1 is operated under a low temperature environment or when the intermediate transfer belt 71 is exchanged with a shorter belt.

(Connecting Operation of Secondary Transfer Unit and Tension Roller)

Next, a connecting operation of the secondary transfer unit 8 and the protruding section 80 will be described with reference to FIG. 4A.

When the connecting member 83 is rotated in the C direction, so that the connection between the secondary transfer roller 81 and the protruding section 80 is released, the step section 86 of the connecting member 83 is separated from the protruding section 80 and connection between the secondary transfer unit 8 and the tension roller 73 is released.

From a state where the connecting member 83 is in a position of releasing the connection between the tension roller 73 and the secondary transfer unit 8, when the connecting member 83 is rotated in the D direction, the protruding section 80 comes into contact with the recess section 85 of the connecting member 83. Then, the protruding section 80 is supported by the step section 86, which results in a state in which the secondary transfer unit 8 and the protruding section 80 are connected.

(Operation when Handling a Jam)

Next, a jam handling when a sheet 30 is jammed will be described.

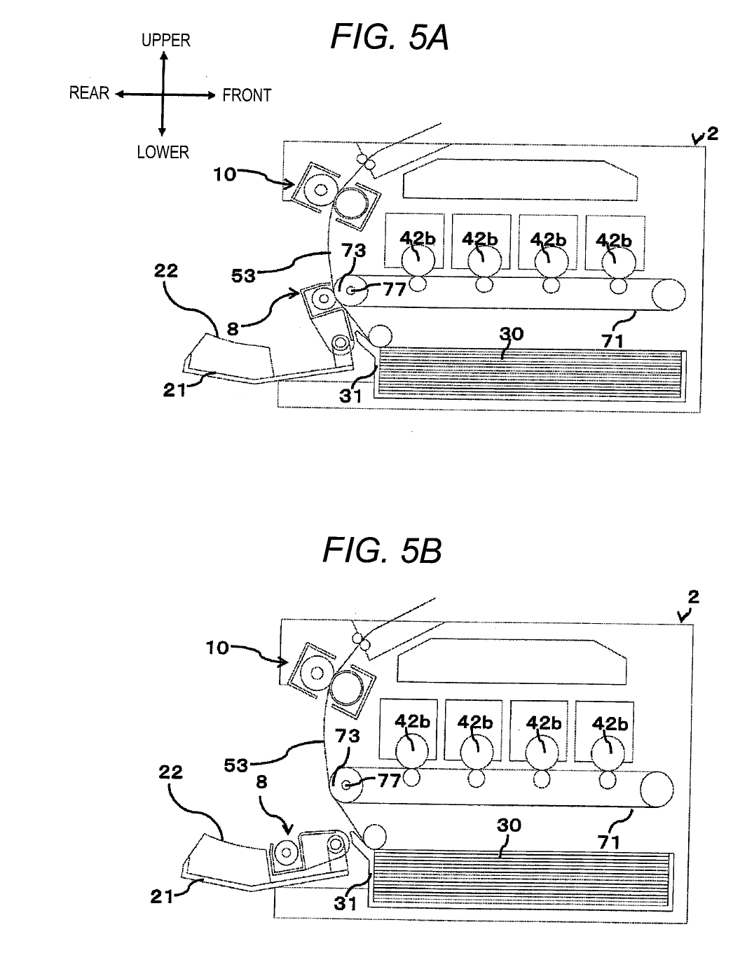

When the sheet 30 is jammed in a sheet transport path 53, firstly, the rear cover 21 of the body housing 2 is opened as shown in FIG. 5A. In this state, the sheet 30 can be removed, which is stopped at a downstream from the secondary transfer unit 8 and at an upstream from the fixing unit 10 in the sheet transport direction. When the sheet 30 is jammed between the secondary transfer unit 8 and the intermediate transfer belt 71, the connecting member 83 which connects the secondary transfer unit 8 and the protruding section 80 is released. Then, as shown in FIG. 5B, the secondary transfer unit 8 is rotated in a counterclockwise direction, whereby the sheet transport path 53 between the secondary transfer unit 8 and the sheet tray 31 is opened. Since the sheet transport path 53 is opened widely, the jammed sheet can be easily removed.

Next, effects of the above-described color laser printer 1 will be described.

In the color laser printer 1 according to the first illustrative embodiment, the secondary transfer unit 8 has the secondary transfer roller 81, the guide member 96 and the connecting member 83 which connects the secondary transfer unit 8 and the protruding section 80 with each other. Thus, the guide member 96 changes its position to follow the movement of the tension roller 73, the guide member 96 can accurately guide the sheet 30 to the secondary transfer nip position N. Therefore, it is possible to accurately perform a secondary transfer of a toner image onto the sheet 30.

In addition, since the connecting member 83 suppresses a change of the distance between the rotating shaft 82 of the secondary transfer roller 81 and the rotating shaft 77 of the tension roller 73, linkage of the tension roller 73 and the secondary transfer unit 8 is good. Therefore, the sheet 30 is guided further accurately.

Further, since the frame rotating shaft section 97 of the secondary transfer unit 8 is provided at an upstream side in the sheet transport direction, even though the downstream end of the guide member 96 in the sheet transport direction moves significantly, the upstream end of the guide member 96 in the sheet transport direction does not move so much. Accordingly, the leading end of the sheet 30 can enter the guide member 96 smoothly.

In addition, the connecting member 83 can rotate about the connecting member rotating section 87 between a position at which the connecting member 83 is connected with the tension roller 73 and a position at which the connection with the tension roller 73 is released. Further, when the connecting member 83 releases the connection between the tension roller 73 and the secondary transfer roller 81, the secondary transfer unit 8 can rotate between a position at which the secondary transfer roller 81 and the tension roller 73 are in contact with each other and a position at which the secondary transfer roller 81 and the tension roller 73 are separated from each other. As described above, since the connecting member 83 and the secondary transfer unit 8 is rotatable, the sheet transport path 53 can be opened widely and a jammed sheet can be removed easily.

In addition, the secondary transfer roller 81 is covered by the top frame 91, the rear frame 92, the side frames 93 and the bottom frame 94. As described above, since the surface of the secondary transfer roller 81 is covered, for example, even if the secondary transfer unit 8 is abruptly opened and comes into contact with the rear cover 21, the surface of the secondary transfer roller 81 would not be damaged.

### Second Illustrative Embodiment

Next, a second illustrative embodiment will be described.

In the second illustrative embodiment, only the configuration different from the first illustrative embodiment will be described, and the components same as the first illustrative embodiment are attached with the same reference numerals and the description thereof will be omitted.

(Configuration of Secondary Transfer Unit)

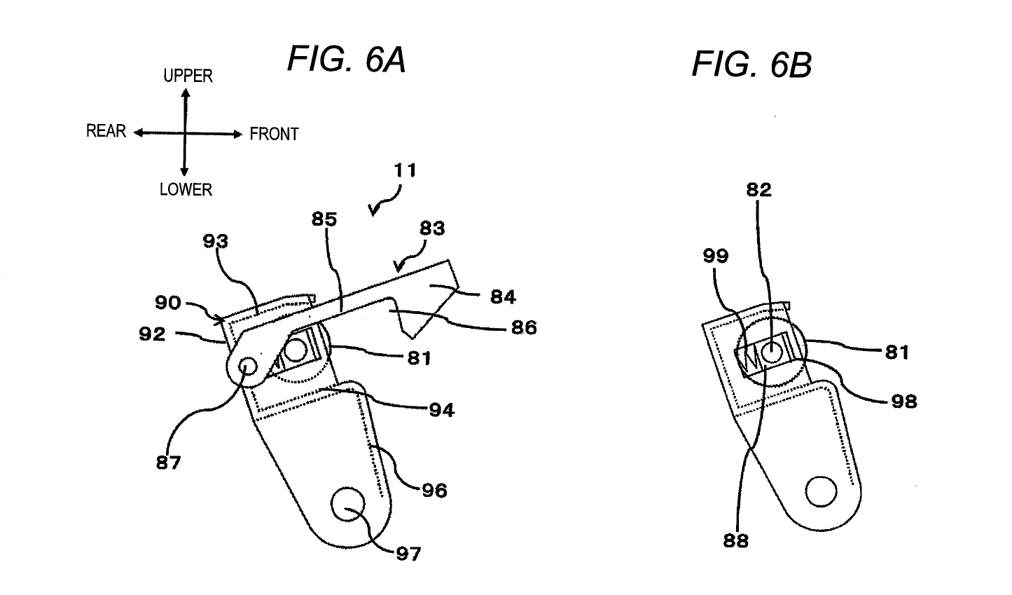

The secondary transfer roller 81 has a second rotating shaft supporting member 88 as shown in FIG. 6B. The second rotating shaft supporting member 88 rotatably supports the rotating shaft 82 of the secondary transfer roller 81. Further, the second rotating shaft supporting member 88 is provided so as not to interfere with the connecting member 83.

The side frame 93 of the first frame 90 has a supporting hole section 98 formed therein. The supporting hole section 98 has an elongated hole shape which is long in a direction (a front-rear direction) in which the secondary transfer roller 81 and the tension roller 73 oppose with each other in a state where the tension roller 73 is connected, and slidably supports the second rotating shaft supporting member 88 of the secondary transfer roller 81.

The supporting hole section 98 has a spring 99 which presses the second rotating shaft supporting member 88 from the rear end of the supporting hole section 98 toward the tension roller 73. As the secondary transfer roller 81 contacts the tension roller 73, the spring 99 applies a load to the secondary transfer roller 81.

The connecting member rotating section 87 is provided at a rear side of the side frame 93 of the secondary transfer unit 8 and is provided at a position different from the rotating shaft 82 of the secondary transfer roller 81.

(Operation of Secondary Transfer Unit when the Tension Roller Moves)

If the tension roller 73 moves rearward, the contact pressure with the secondary transfer roller 81 becomes stronger, and the secondary transfer unit 11 rotates rearward. The connecting member 83 suppresses the force in a direction in which the secondary transfer unit 11 is separated from the tension roller 73. At this time, even though the secondary transfer unit 11 moves with the movement of the tension roller 73, the spring 99 applies substantially same load to the secondary transfer roller 81.

(Operation when Secondary Transfer Roller is Eccentric)

Next, the operation when the secondary transfer roller 81 is eccentric will be described.

According to eccentricity of the secondary transfer roller 81, the spring 99 is deformed, so that the rotating shaft 82 of the secondary transfer roller 81 slides in the front-rear direction in the supporting hole section 98. At this time, the secondary transfer unit 11 and the rotating shaft 77 of the tension roller 73 are in a connected state. Accordingly, the eccentricity of the secondary transfer roller 81 does not move the tension roller 73, but causes only the secondary transfer roller 81 to slide in the supporting hole section 98.

Next, effects of the above-described color laser printer 1 will be described.

In the color laser printer 1 according to the second illustrative embodiment, the secondary transfer unit 11 has the connecting member 83 and the spring 99 which presses the secondary transfer roller 81 toward the tension roller 73. Thus, since the spring 99 is deformed even though the secondary transfer roller 81 is eccentric, it is possible to suppress the change of the nip pressure of the tension roller 73 and the secondary transfer roller 81. Further, since the secondary transfer roller 81 is not affected by movement of the tension roller 73 even though the secondary transfer roller 81 is eccentric, it is possible to reliably stretch the primary transfer area.

### Other Illustrative Embodiment

While the present invention has been shown and described with reference to certain illustrative embodiments thereof, it will be understood by those skilled in the art that various changes in form and details may be made therein without departing from the spirit and scope of the invention as defined by the appended claims.

For example, although the color laser printer is described in the above-described illustrative embodiments, the preset invention may be applied to a monochrome laser printer.

In addition, although the rotating shaft of the connecting member is provided at the secondary transfer unit in the above-described illustrative embodiments, the rotating shaft of the connecting member may be provided at the tension roller side.

In addition, although the inside of the intermediate transfer belt is supported at both ends by two points of the tension roller and the driving roller in the above-described illustrative embodiments, a plurality of the driven rollers may be provided to support the intermediate transfer belt, in addition to the tension roller and the driving roller.

What is claimed is:

1. An image forming apparatus comprising:
an intermediate transfer belt having a primary transfer area to which a toner image formed on a photosensitive drum is primarily transferred;
a driving roller configured to supply a driving force to the intermediate transfer belt;
a tension roller provided to be movable with respect to the driving roller to apply tension to the intermediate transfer belt;
a secondary transfer roller configured to transfer the toner image transferred to the intermediate transfer belt onto a sheet; and
a guide member configured to guide the sheet to a nip position between the secondary transfer roller and the intermediate transfer belt,
wherein the driving roller is provided to support a downstream end of the primary transfer area in a direction in which the toner image transferred on the primary transfer area is conveyed,
wherein the secondary transfer roller is provided at a position opposing the tension roller, and
wherein the guide member is connected to the tension roller so as to follow a movement of the tension roller.

2. The image forming apparatus according to claim 1, further comprising a secondary transfer unit which integrates the secondary transfer roller and the guide member,
wherein the secondary transfer unit includes a connecting member which is configured to be connected with a rotating shaft of the tension roller.

3. The image forming apparatus according to claim 2,
wherein the secondary transfer unit includes a spring which press the secondary transfer roller toward the tension roller.

4. The image forming apparatus according to claim 2, further comprising:
a sheet transporting unit configured to transport a sheet,
wherein the secondary transfer unit is rotatably supported about an upstream end thereof in a sheet transport direction.

5. The image forming apparatus according to claim 2,
wherein the connecting member is movable between a position at which the connecting member is connected with the tension roller and a position at which the connection between the connecting member and the tension roller is released, and
wherein the secondary transfer unit is rotatable about an upstream end in the sheet transport direction between a position at which the secondary transfer unit is connected with the tension roller and a position at which the secondary transfer unit is separated from the tension roller.

6. An image forming apparatus comprising:
a driving roller;
a tension roller provided to be movable with respect to the driving roller;
an intermediate transfer belt which is turned around the driving roller and the tension roller, and to which a toner image formed on a photosensitive drum is transferred;
a pressing member which presses the tension roller to the intermediate transfer belt;
a secondary transfer unit provided to be movable with respect to the driving roller and including a secondary transfer roller opposing the tension roller with the intermediate transfer belt therebetween;
a sheet transport unit configured to transport a sheet through between the tension roller and the secondary transfer roller; and
a connecting member provided to be movable between a position which connects a rotating shaft of the tension roller and the secondary transfer unit and a position which does not connect the rotating shaft of the tension roller and the secondary transfer unit.
